(19) United States
(12) Patent Application Publication
(10) Pub. No.: US 2026/0360623 A1
(43) Pub. Date: Nov. 12, 2026

(54) MULTILAYER CERAMIC CAPACITOR

(71) Applicant: Murata Manufacturing Co., Ltd., Nagaokakyo-shi (JP)

(72) Inventors: Takuya KITANO, Nagaokakyo-shi (JP); Hikaru OKUDA, Nagaokakyo-shi (JP)

(21) Appl. No.: 19/734,460

(22) Filed: Jul. 8, 2026

Related U.S. Application Data
(63) Continuation of application No. PCT/JP2025/035444, filed on Oct. 6, 2025.

(30) Foreign Application Priority Data
Oct. 10, 2024 (JP) 2024-177771

(51) Int. Cl. H01G 4/232; H01G 4/008; H01G 4/12; H01G 4/248; H01G 4/30; H01G 13/00

(52) U.S. Cl. CPC H01G 4/2325; H01G 4/008; H01G 4/1227; H01G 4/30; H01G 13/006; H01G 4/248

(57) ABSTRACT

A multilayer ceramic capacitor includes a multilayer body includes first through sixth surfaces, a first outer electrode located on the third, first, second, fifth, and sixth surfaces and a second outer electrode located on the fourth, first, second, fifth, and sixth surfaces, and has a first-direction dimension of about 0.15 mm to about 0.17 mm, a second-direction dimension of about 0.075 mm to about 0.085 mm, and a lamination-direction dimension of about 0.05 mm to about 0.10 mm. A relationship of about 0.31≤g1/e1≤about 2.00 is satisfied where e1 a value obtained by dividing, by 2, a sum of a dimension of the first outer electrode in the first direction and a dimension of the second outer electrode in the first direction at a second-direction position at which a first-direction distance between the first and second outer electrodes is a minimum distance on the first surface side.

### CROSS REFERENCE TO RELATED APPLICATIONS

This application claims the benefit of priority to Japanese Patent Application No. 2024-177771 filed on Oct. 10, 2024 and is a Continuation Application of PCT Application No. PCT/JP2025/035444 filed on Oct. 6, 2025. The entire contents of each application are hereby incorporated herein by reference.

### BACKGROUND OF THE INVENTION

### 1. Field of the Invention

The present invention relates to multilayer ceramic capacitors.

### 2. Description of the Related Art

In association with miniaturization of electronic devices, miniaturization of dimensions of multilayer electronic components is also required. For example, as described in Japanese Unexamined Patent Application Publication No. 2023-63887, a multilayer ceramic capacitor having a length of 0.25 mm, a width of 0.125 mm, and a height of 0.125 mm as the size of the multilayer ceramic capacitor is known.

### SUMMARY OF THE INVENTION

When a multilayer ceramic capacitor is smaller than the above-described size, the mass of the multilayer ceramic capacitor is small, and thus tombstoning is likely to occur. Further, the distance between outer electrodes is short, which may cause deterioration of insulation resistance.

Example embodiments of the present invention provide, as multilayer ceramic capacitors having a small size, multilayer ceramic capacitors in which the possibility of occurrence of tombstoning and deterioration of insulation resistance is reduced.

An example embodiment of the present invention provides a multilayer ceramic capacitor including a multilayer body including a first surface and a second surface facing each other in a lamination direction, a third surface and a fourth surface facing each other in a first direction intersecting the lamination direction, and a fifth surface and a sixth surface facing each other in a second direction intersecting the lamination direction and the first direction. The multilayer ceramic capacitor also includes outer electrodes including a first outer electrode on the third surface, the first surface, the second surface, the fifth surface, and the sixth surface, and a second outer electrode on the fourth surface, the first surface, the second surface, the fifth surface, and the sixth surface. A dimension in the first direction is about 0.150 mm or more and about 0.170 mm or less. A dimension in the second direction is about 0.075 mm or more and about 0.085 mm or less. A dimension in the lamination direction is about 0.050 mm or more and about 0.100 mm or less. When the multilayer ceramic capacitor is viewed from the first surface side, about 0.31≤g1/e1≤about 2.00 where e1 is defined as (e11+e12)/2 obtained by dividing, by 2, a sum of a dimension e11 of the first outer electrode in the first direction and a dimension e12 of the second outer electrode in the first direction at a position in the second direction on the first surface at which a distance in the first direction between the first outer electrode and the second outer electrode is a minimum distance g1.

According to example embodiments of the present invention, it is possible to provide, as multilayer ceramic capacitors each having a small size, the multilayer ceramic capacitors in which the possibility of occurrence of tombstoning and deterioration of insulation resistance is reduced.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a schematic perspective view of a multilayer ceramic capacitor 1.

FIG. 2 is a partial cross-sectional view of the multilayer ceramic capacitor 1 taken along line II-II in FIG. 1.

FIG. 3 is a cross-sectional view of the multilayer ceramic capacitor 1 taken along line III-III in FIG. 1.

FIG. 4 is an exploded perspective view of a multilayer body 2 for explaining a structure of first inner electrodes 5A and second inner electrodes 5B in an example embodiment of the present invention.

FIG. 5 is a diagram for explaining a modification of a structure of inner electrodes 5.

FIG. 6 is a diagram for explaining a modification of the structure of the inner electrodes 5.

FIG. 7 is a diagram for explaining a modification of the structure of the inner electrodes 5.

FIG. 8 is a schematic diagram of the multilayer ceramic capacitor 1 as viewed from a first surface A1 side.

FIG. 9 is a schematic diagram of the multilayer ceramic capacitor 1 as viewed from a fifth surface B1 side.

FIG. 10 is a flowchart depicting a manufacturing method for the multilayer ceramic capacitor 1 according to an example embodiment of the present invention.

FIG. 11 is a table showing results that were obtained by measuring the weights of 100 ceramic capacitors 1 in lot 1 and calculating the weight per capacitor.

FIG. 12 is a table showing results of validation of insulation resistance and presence or absence of occurrence of tombstoning regarding the multilayer ceramic capacitors 1 of the example embodiments in lot 1.

FIG. 13 is a table showing results of validation of the insulation resistance and presence or absence of occurrence of the tombstoning regarding the multilayer ceramic capacitors 1 of the example embodiments in lot 2.

FIG. 14 is a table showing results of validation of the insulation resistance and presence or absence of occurrence of the tombstoning regarding the multilayer ceramic capacitors 1 of the example embodiments in lot 3.

### DETAILED DESCRIPTION OF THE EXAMPLE EMBODIMENTS

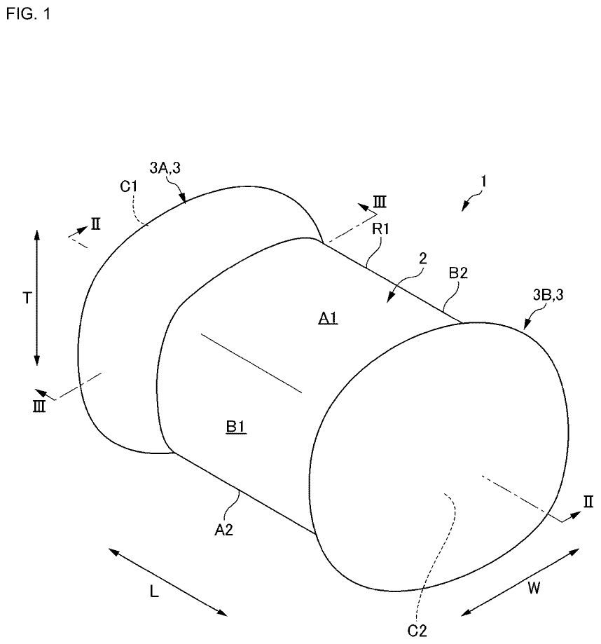

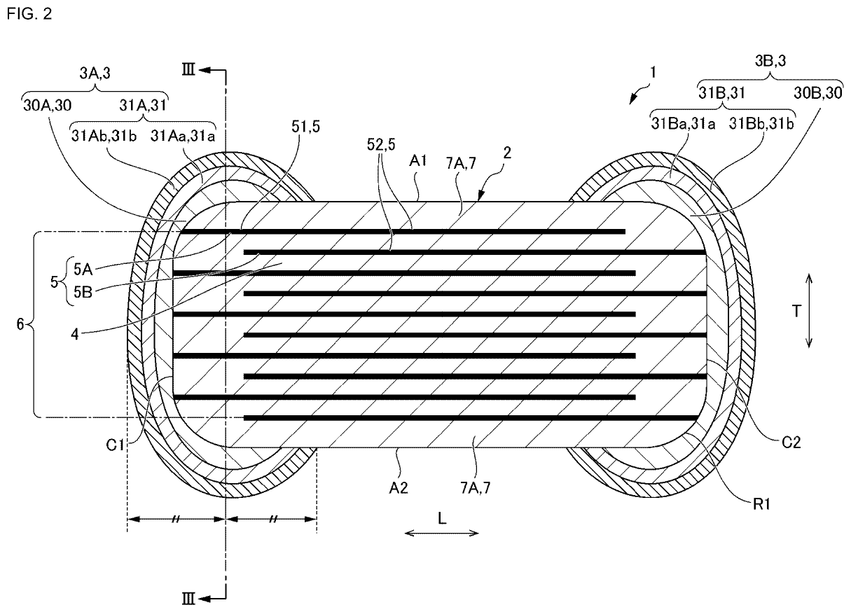

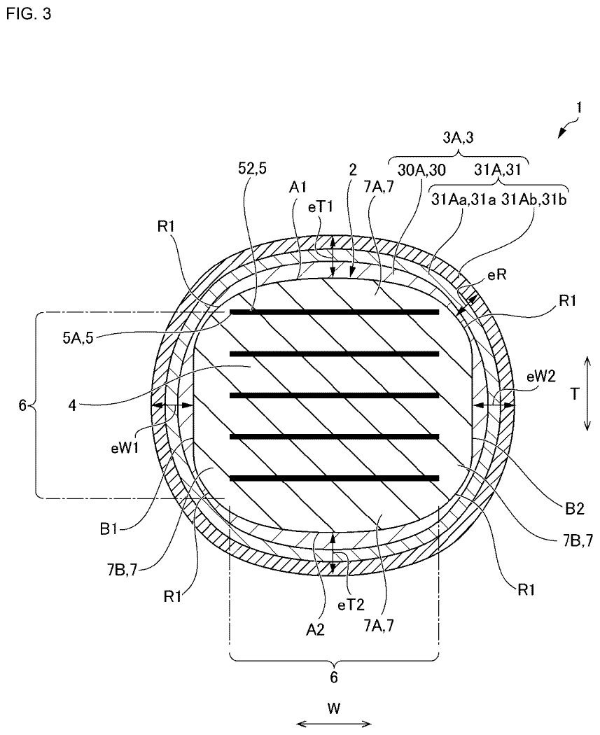

Example embodiments of the present invention are described below. FIG. 1 is a schematic perspective view of a multilayer ceramic capacitor 1 according to an example embodiment of the present invention. FIG. 2 is a partial cross-sectional view of the multilayer ceramic capacitor 1 taken along line II-II in FIG. 1. FIG. 3 is a cross-sectional view of the multilayer ceramic capacitor 1 taken along line III-III in FIGS. 1 and 2.

The multilayer ceramic capacitor 1 includes a multilayer body 2 having a substantially rectangular parallelepiped shape or a substantially cylindrical shape and a pair of outer electrodes 3 at both ends of the multilayer body 2. Further, the multilayer body 2 includes an active portion 6 including a plurality of sets of dielectric layers 4 and inner electrodes 5.

In the following description, as a term representing an orientation of the multilayer ceramic capacitor 1, a direction perpendicular to a mounting surface is defined as a lamination direction T. In the present example embodiment, a direction in which the inner electrodes 5 and the dielectric layers 4 are laminated is defined as the lamination direction T.

Further, a direction in which the pair of outer electrodes 3 are provided is defined as a first direction L. A direction intersecting both the first direction L and the lamination direction T is defined as a second direction W. In the present example embodiment, the first direction L, the second direction W, and the lamination direction T are orthogonal to each other. At this time, the direction in which the inner electrodes 5 and the dielectric layers 4 are laminated may be set as a direction parallel to the mounting surface, and the lamination direction T may be defined as a direction perpendicular to the direction in which the inner electrodes 5 and the dielectric layers 4 are laminated.

Dimensions of the multilayer ceramic capacitor 1 of the present example embodiment of the present invention, including the outer electrodes 3, are as follows: a dimension in the first direction L is about 0.150 mm or more and about 0.170 mm or less, a dimension in the second direction W is about 0.075 mm or more and about 0.085 mm or less, and a dimension in the lamination direction T is about 0.050 mm or more and about 0.100 mm or less. Further, a mass m of the multilayer ceramic capacitor 1 satisfies about 1 μg≤m≤about 10 μg, for example.

The multilayer body 2 includes a first surface A1 and a second surface A2 facing each other in the lamination direction T, a third surface C1 and a fourth surface C2 facing each other in the first direction L, and a fifth surface B1 and a sixth surface B2 facing each other in the second direction W.

In the present example embodiment, in the multilayer body 2, ridge portions R1 between two adjacent surfaces and corner portions among three adjacent surfaces are rounded. This can reduce or prevent chipping at angular portions of the multilayer body 2.

The multilayer body 2 includes the active portion 6 and an inactive portion 7. The active portion 6 is a region in which the inner electrodes 5 and the dielectric layers 4 are laminated. The inactive portion 7 is a region in which the inner electrodes 5 are not disposed, and includes outer layer portions 7A on both sides of the active portion 6 in the lamination direction T and side gap portions 7B on both sides of the active portion 6 in the second direction W.

A main component of the dielectric layers 4 is preferably BaTiO₃, but is not particularly limited. A thickness of the dielectric layer 4 (after firing) is preferably about 0.40 μm or more and about 3.00 μm or less, for example. Further, it is preferable that Sn layers be present at interfaces each between the dielectric layer 4 and the inner electrode 5. When the inner electrodes 5 include Sn, the Sn layers may be derived from the Sn included in the inner electrodes 5. Alternatively, when the dielectric layers 4 include Sn, the Sn layers may be derived from the Sn included in the dielectric layers 4.

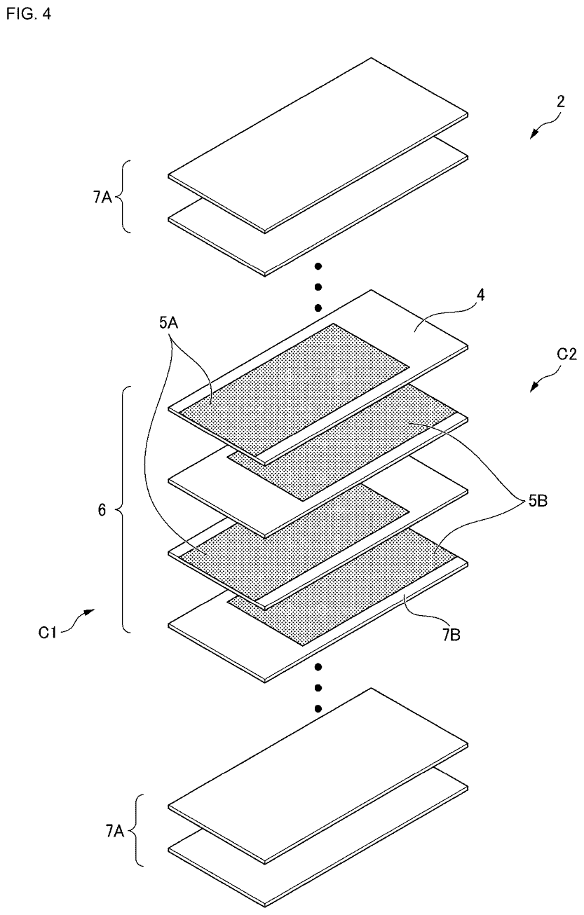

The inner electrodes 5 include first inner electrodes 5A exposed on the third surface C1 and second inner electrodes 5B exposed on the fourth surface C2. FIG. 4 is an exploded perspective view of the multilayer body 2 for explaining a structure of the first inner electrodes 5A and the second inner electrodes 5B.

In the present example embodiment, a main component of the inner electrodes 5 is Ni, but is not limited thereto. A thickness of the inner electrode 5 is preferably about 0.20 μm or more and about 1.50 μm or less, for example.

As depicted in FIG. 2, the inner electrodes 5 include opposing portions 52 opposed to each other between the first inner electrode 5A and the second inner electrode 5B and extended portions 51 that are not opposed to each other between the first inner electrode 5A and the second inner electrode 5B and are each extended from the opposing portion 52 toward the third surface C1 side or the fourth surface C2 side. A direction in which the extended portion 51 extends differs between the first inner electrode 5A and the second inner electrode 5B, and the extended portions 51 are extended toward the third surface C1 side and the fourth surface C2 side. End portions of the extended portions 51 of the first inner electrodes 5A are exposed on the third surface C1, and are electrically connected to a first outer electrode 3A. End portions of the extended portions 51 of the second inner electrodes 5B are exposed on the fourth surface C2, and are electrically connected to a second outer electrode 3B. That is, the dielectric layers 4 on which the first inner electrodes 5A exposed on the third surface C1 are disposed and the dielectric layers 4 on which the second inner electrodes 5B exposed on the fourth surface C2 are disposed are alternately laminated. Further, a charge is accumulated between the opposing portions 52 of the first inner electrode 5A and the second inner electrode 5B adjacent to each other in the lamination direction T, and the multilayer ceramic capacitor 1 functions as a capacitor.

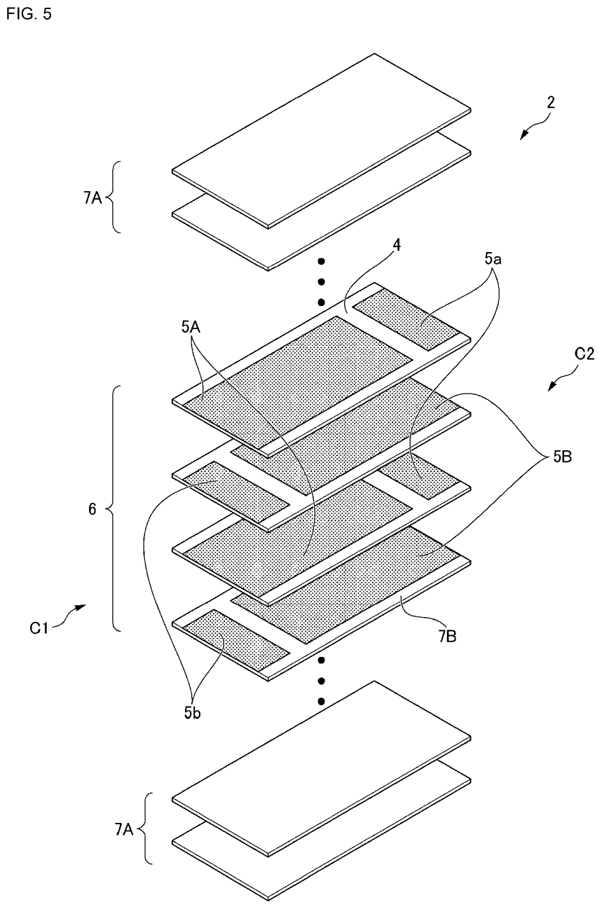

However, the structure of the inner electrodes 5 of an example embodiment of the present invention is not limited thereto, and various structures are possible. For example, FIGS. 5, 6, and 7 are diagrams for explaining modifications of the structure of the inner electrodes 5. These modifications are described below, and the description is made such that portions similar to those in the above-described example embodiments are given the same reference numerals.

FIG. 5 is a diagram depicting a first modification of the structure of the inner electrodes 5. In the inner electrodes 5 of the first modification, as in the present example embodiment depicted in FIG. 4, the dielectric layers 4 on which the first inner electrodes 5A exposed on the third surface C1 are disposed and the dielectric layers 4 on which the second inner electrodes 5B exposed on the fourth surface C2 are disposed are alternately laminated. Further, the dielectric layers 4 on which the first inner electrodes 5A exposed on the third surface C1 are located include first dummy electrodes 5a that are each spaced apart from the first inner electrode 5A and are exposed on the fourth surface C2. The dielectric layers 4 on which the second inner electrodes 5B exposed on the fourth surface C2 are located include second dummy electrodes 5b that are each spaced apart from the second inner electrode 5B and are exposed on the third surface C1.

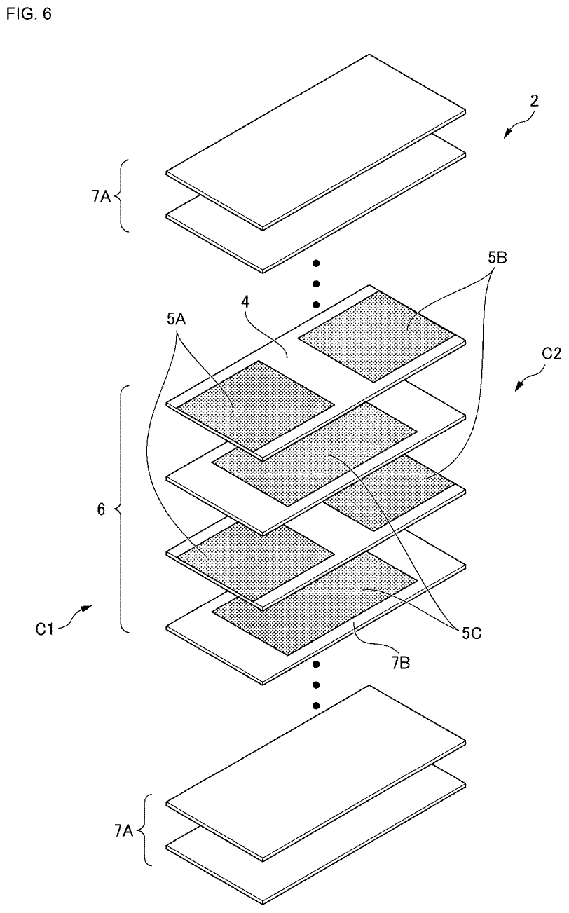

FIG. 6 is a diagram depicting a second modification of the structure of the inner electrodes 5. In the inner electrodes 5 of the second modification, the dielectric layers 4 on which the first inner electrodes 5A exposed on the third surface C1 and the second inner electrodes 5B exposed on the fourth surface C2 are disposed and the dielectric layers 4 on which non-connected inner electrodes 5C exposed on neither the third surface C1 nor the fourth surface C2 are disposed are alternately laminated. With such a configuration, even if a crack or the like occurs in the multilayer body 2 and a partial short circuit occurs, it is possible to avoid the occurrence of a defect such as a short circuit of the entire multilayer ceramic capacitor.

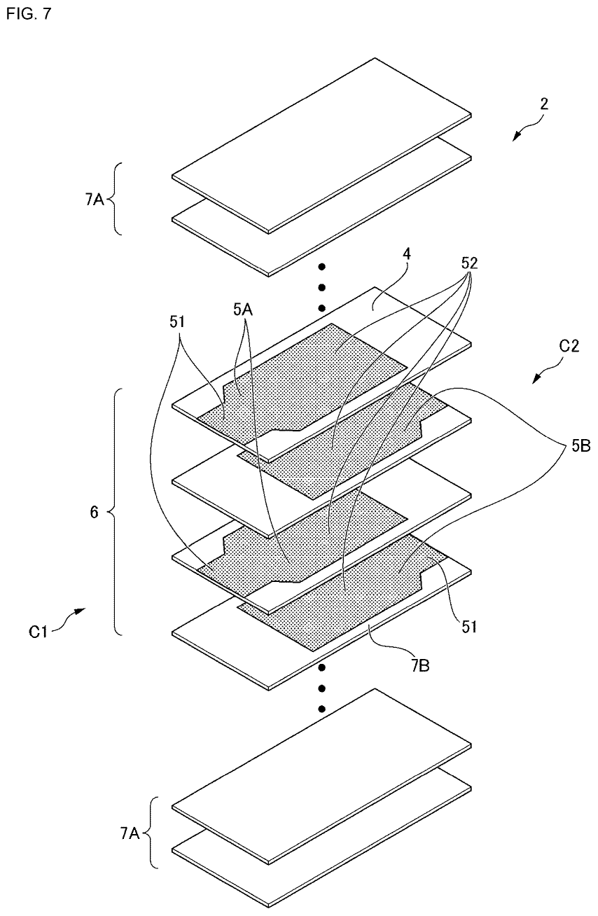

FIG. 7 is a diagram depicting a third modification of the structure of the inner electrodes 5. The inner electrodes 5 of the third modification include the first inner electrodes 5A exposed on the third surface C1 and the second inner electrodes 5B exposed on the fourth surface C2 as in the present example embodiment depicted in FIG. 4. A point different from the above example embodiment is that a width on the third surface C1 side or the fourth surface C2 side regarding the extended portion 51 of each inner electrode 5 is smaller than the width of the opposing portion 52.

Returning to the present example embodiment, the outer layer portions 7A are each on a respective one of the first surface A1 side and the second surface A2 side of the active portion 6. The outer layer portions 7A may be manufactured from the same material as the dielectric layers 4 of the active portion 6. A thickness of the outer layer portion 7A is preferably about 5 μm or more and about 25 μm or less, for example.

The side gap portions 7B are each on a respective one of the fifth surface B1 side and the sixth surface B2 side of the active portion 6 of the multilayer body 2. The side gap portions 7B may be manufactured from the same material as the dielectric layers 4.

The outer electrodes 3 include the first outer electrode 3A and the second outer electrode 3B. The first outer electrode 3A is on the third surface C1, and further extends to the first surface A1, the second surface A2, the fifth surface B1, and the sixth surface B2. The second outer electrode 3B is on the fourth surface C2, and further extends to the first surface A1, the second surface A2, the fifth surface B1, and the sixth surface B2.

The first outer electrode 3A includes a first underlying electrode layer 30A and a first plated layer 31A. The first underlying electrode layer 30A is connected to the first inner electrodes 5A. The first underlying electrode layer 30A is on the third surface C1 and on the first surface A1, the second surface A2, the fifth surface B1, and the sixth surface B2.

The first plated layer 31A includes a first inner plated layer 31Aa that is a Ni plated layer on the first underlying electrode layer 30A, and a first outer plated layer 31Ab that is a Sn plated layer on the first inner plated layer 31Aa.

The second outer electrode 3B includes a second underlying electrode layer 30B and a second plated layer 31B. The second underlying electrode layer 30B is connected to the second inner electrodes 5B. The second underlying electrode layer 30B is on the fourth surface C2 and on the first surface A1, the second surface A2, the fifth surface B1, and the sixth surface B2.

The second plated layer 31B includes a second inner plated layer 31Ba that is a Ni plated layer on the second underlying electrode layer 30B, and a second outer plated layer 31Bb that is a Sn plated layer on the second inner plated layer 31Ba.

Hereinafter, when it is not required to distinguish between the first outer electrode 3A and the second outer electrode 3B, they are collectively described as the outer electrodes 3. When it is not required to distinguish between the first underlying electrode layer 30A and the second underlying electrode layer 30B, they are collectively described as the underlying electrode layers 30. When it is not required to distinguish between the first plated layer 31A and the second plated layer 31B, they are collectively described as the plated layers 31. When it is not required to distinguish between the first inner plated layer 31Aa and the second inner plated layer 31Ba, they are collectively described as the inner plated layers 31a. When it is not required to distinguish between the first outer plated layer 31Ab and the second outer plated layer 31Bb, they are collectively described as the outer plated layers 31b.

The underlying electrode layers 30 include a metal component and a glass component, or a metal component and a ceramic component. In the present example embodiment, the underlying electrode layers 30 include Cu as a metal component.

The inner plated layers 31a, which are the Ni plated layers, can prevent the underlying electrode layers 30 from being eroded by solder when a ceramic electronic component is mounted. The outer plated layers 31b, which are the Sn plated layers, improve wettability of solder when the multilayer ceramic capacitor 1 is mounted. The plated layers 31 are not limited to the two-layer structure, and may have a single-layer structure or a structure of three or more layers.

In the present example embodiment, as described above, the main component of the inner electrodes 5 is Ni, and the underlying electrode layers 30 include a Cu component. In addition, the outer electrodes 3 include, as the plated layers 31, the inner plated layers 31a, which are the Ni plated layers, and the outer plated layers 31b, which are the Sn plated layers. Further, in the present example embodiment, the underlying electrode layers 30 are manufactured by a post-firing method in which a conductive paste is applied to the multilayer body 2 after firing and then baked. However, the underlying electrode layers 30 are not limited thereto, and may be formed, for example, by a co-firing method in which they are fired simultaneously with the multilayer body 2. In addition, the structure and the like of the outer electrodes 3 of example embodiments the present invention are not limited thereto, and the outer electrodes 3 may have, for example, a structure of the following modifications.

In modification 1 of the outer electrodes 3, the main component of the inner electrodes 5 may be Ni. The underlying electrode layers 30 may include a Ni component. The plated layers 31 may include the inner plated layers 31a that are Ni plated layers and the outer plated layers 31b that are Sn plated layers. The underlying electrode layers 30 including the Ni component may be manufactured by a co-firing method in which they are fired simultaneously with the multilayer body 2.

In modification 2 of the outer electrodes 3, the main component of the inner electrodes 5 may be Ni. The underlying electrode layers 30 may include a first underlying electrode layer including a Ni component and a second underlying electrode layer including a Cu component. The outer electrodes 3 may include, as the plated layers 31, the inner plated layers 31a that are Ni plated layers and the outer plated layers 31b that are Sn plated layers. The first underlying electrode layer 30A including the Ni component may be manufactured by a co-firing method in which it is fired simultaneously with the multilayer body 2, and the second underlying electrode layer 30B including the Cu component may be manufactured by a post-firing method.

In modification 3 of the outer electrodes 3, the main component of the inner electrodes 5 may be Cu. The underlying electrode layers 30 may include a Cu component. The plated layers 31 may include the inner plated layers 31a that are Ni plated layers and the outer plated layers 31b that are Sn plated layers. The underlying electrode layers 30 may be manufactured by a co-firing method in which they are fired simultaneously with the multilayer body 2, or may be manufactured by a post-firing method.

In modification 4 of the outer electrodes 3, the main component of the inner electrodes 5 may be Ni. The multilayer ceramic capacitor 1 may include seed layers on a surface of the multilayer body 2, and Cu plated layers may be formed as the underlying electrode layers 30 on the seed layers. Further, the outer electrodes 3 may include, as the plated layers 31, the inner plated layers 31a that are Ni plated layers and the outer plated layers 31b that are Sn plated layers.

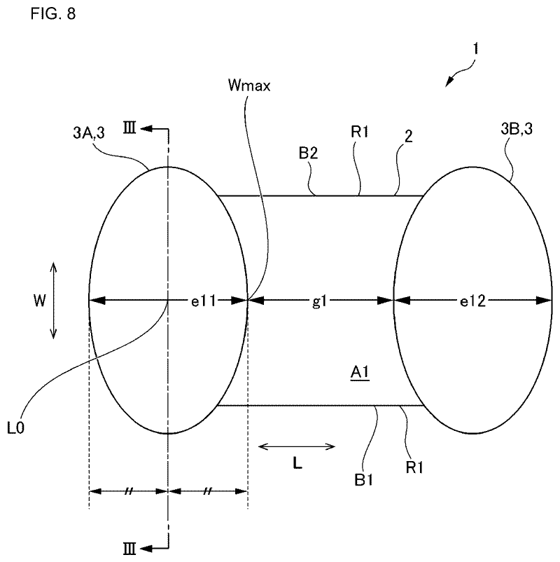

FIG. 8 is a schematic diagram of the multilayer ceramic capacitor 1 as viewed from the first surface A1 side. In FIG. 8, e11 and e12 are defined as the dimension of the first outer electrode 3A in the first direction L and the dimension of the second outer electrode 3B in the first direction L, respectively, at a position in the second direction W (in the present example embodiment, Wmax) at which the distance in the first direction L between the first outer electrode 3A and the second outer electrode 3B is a minimum distance g1. Further, when (e11+e12)/2 obtained by dividing the sum of e11 and e12 by 2 is defined as e1, the multilayer ceramic capacitor 1 of the present example embodiment satisfies about 0.31≤g1/e1≤about 2.00, for example. More preferably, about 0.31≤g1/e1≤about 1.00, for example.

In the multilayer ceramic capacitor 1, when the multilayer ceramic capacitor 1 is viewed from the second surface A2 side as well, a value obtained by dividing, by 2, the sum of the dimension of the first outer electrode 3A in the first direction L and the dimension of the second outer electrode 3B in the first direction L at a position in the second direction W at which the distance in the first direction L between the first outer electrode 3A and the second outer electrode 3B is a minimum distance is preferably about 0.31 or more and about 2.00 or less, more preferably about 0.31 or more and about 1.00 or less, and still more preferably about 0.31 or more and less than about 1.00, for example.

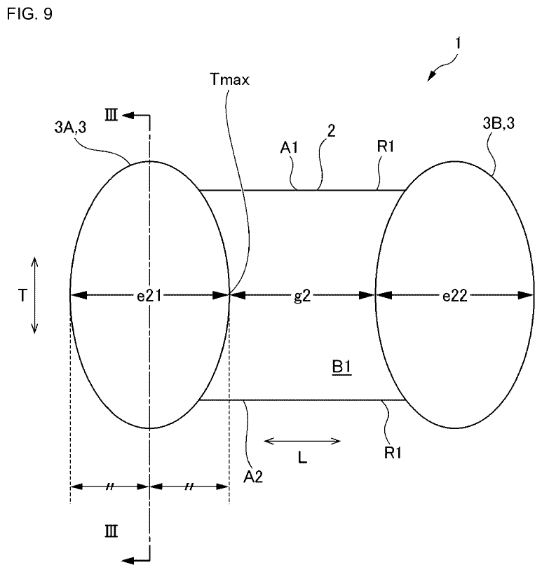

FIG. 9 is a schematic diagram of the multilayer ceramic capacitor 1 as viewed from the fifth surface B1 side. In FIG. 9, e21 and e22 are defined as the dimension of the first outer electrode 3A in the first direction L and the dimension of the second outer electrode 3B in the first direction L, respectively, at a position Tmax in the lamination direction T at which the distance in the first direction L between the first outer electrode 3A and the second outer electrode 3B is a minimum distance g2. Further, when (e21+e22)/2 obtained by dividing the sum of e21 and e22 by 2 is defined as e2, the multilayer ceramic capacitor 1 of the present example embodiment satisfies about 0.31≤g2/e2≤about 2.00, for example. More preferably, about 0.31≤g2/e2≤1.00, for example.

In the multilayer ceramic capacitor 1, when the multilayer ceramic capacitor 1 is viewed from the sixth surface B2 side as well, a value obtained by dividing, by 2, the sum of the dimension of the first outer electrode 3A in the first direction L and the dimension of the second outer electrode 3B in the first direction L at a position in the lamination direction T at which the distance in the first direction L between the first outer electrode 3A and the second outer electrode 3B is a minimum distance is preferably about 0.31 or more and about 2.00 or less, more preferably about 0.31 or more and about 1.00 or less, and still more preferably about 0.31 or more and less than about 1.00, for example.

The multilayer ceramic capacitor 1 of the present example embodiment has an extremely small size as follows: the dimension in the first direction L is about 0.150 mm or more and about 0.170 mm or less, the dimension in the second direction W is about 0.075 mm or more and about 0.085 mm or less, and the dimension in the lamination direction T is about 0.050 mm or more and about 0.100 mm or less, for example.

In the multilayer ceramic capacitor 1 having such an extremely small size, the mass is small and a decrease in g1/e1 contributes to mountability, but there is a possibility that insulation resistance deteriorates.

However, because about 0.31≤g1/e1, that is, g1 is about 0.31e1 or more, for example, the minimum distance g1 between the outer electrodes 3 is secured to some extent, and thus the possibility of deterioration of the insulation resistance is reduced.

In the multilayer ceramic capacitor 1 having such an extremely small size, similarly as for the minimum distance g2 between the outer electrodes 3, there is a high possibility that a short circuit occurs between the outer electrodes 3 because the distance between the outer electrodes 3 is originally short. However, in the present example embodiment, because g2 is about 0.31e2 or more, for example, the minimum distance g2 between the outer electrodes 3 is secured to some extent, and the possibility of occurrence of a short circuit is low.

Further, in the multilayer ceramic capacitor 1 having such an extremely small size, when the minimum distance g1 between the outer electrodes 3 on the first surface A1 increases, the dimension e1 of the outer electrodes 3 in the first direction L becomes very small accordingly.

In this case, when the multilayer ceramic capacitor 1 is mounted on a substrate with the first surface A1 side as a mounting surface side, the area of portions on the first surface A1 in the outer electrodes 3 opposed to the mounting surface also becomes extremely small. Accordingly, the mounting of the multilayer ceramic capacitor 1 on the substrate by solder becomes difficult, and adhesive strength also becomes weak. Further, tombstoning is likely to occur because the weight of the outer electrode 3 relative to the multilayer body 2 becomes small.

However, in the present example embodiment, because g1/e1≤about 2.00, the area of portions opposed to the mounting surface in the outer electrodes 3 can be secured to some extent. Thus, mountability on the substrate is ensured, and sufficient adhesive strength can be secured between the multilayer ceramic capacitor 1 and the substrate. Further, the tombstoning is less likely to occur because the weight of the outer electrode 3 relative to the multilayer body 2 does not become excessively small.

In addition, the tombstoning is less likely to occur when the mass m of a region in which the outer electrode 3 is present is sufficiently larger than the mass m of a region in which the outer electrode 3 is not present.

When the minimum distance g2 between the outer electrodes 3 on the fifth surface B1 increases, similarly to g1, the dimension e2 of the outer electrodes 3 in the first direction L becomes very small.

In this case, when the multilayer ceramic capacitor 1 is mounted on a substrate with the fifth surface B1 side as a mounting surface side, the area of portions on the fifth surface B1 in the outer electrodes 3 opposed to the mounting surface also becomes extremely small. Accordingly, the mounting of the multilayer ceramic capacitor 1 on the substrate by solder becomes difficult, and adhesive strength also becomes weak. Further, the tombstoning is likely to occur because the weight of the outer electrode 3 relative to the multilayer body 2 becomes small.

However, in the present example embodiment, because g2/e2≤about 2.00, for example, the area of portions opposed to the mounting surface in the outer electrodes 3 can be secured to some extent. Thus, mountability on the substrate is ensured, and sufficient adhesive strength can be secured between the multilayer ceramic capacitor 1 and the substrate. Further, the tombstoning is less likely to occur because the weight of the outer electrode 3 relative to the multilayer body 2 does not become excessively small.

FIG. 3 is a cross-sectional view of the multilayer ceramic capacitor 1 taken along line III-III depicted in FIGS. 1, 2, 8, and 9. As depicted in FIGS. 2, 8, and 9, FIG. 3 depicts a cross section that extends in the lamination direction T and the second direction W and passes through the center of the outer electrode 3 (in the present example embodiment, the first outer electrode 3A) in the first direction L at positions at which the dimension of the outer electrode 3 in the first direction L is the maximum on the first surface A1, the second surface A2, the fifth surface B1, and the sixth surface B2.

FIG. 8 is a diagram depicting the outer electrodes 3 as viewed from the first surface A1 side. In FIG. 8, a position in the second direction W at which the dimension of the outer electrode 3 in the first direction L is the maximum is indicated by Wmax in the diagram. The center of the outer electrode 3 in the first direction L at this position Wmax in the second direction W is L0. Further, a cross section that passes through L0 and extends in the lamination direction T and the second direction W corresponds to FIG. 3.

In FIG. 3, the maximum thickness of the outer electrode 3 on the first surface A1 in the normal direction to the first surface A1 is defined as eT1. The maximum thickness of the outer electrode 3 on the second surface A2 in the normal direction to the second surface A2 is defined as eT2. The maximum thickness of the outer electrode 3 on the fifth surface B1 in the normal direction to the fifth surface B1 is defined as eW1. The maximum thickness of the outer electrode 3 on the sixth surface B2 in the normal direction to the sixth surface B2 is defined as eW2. The minimum thickness in the normal direction to the surface of the multilayer body 2 regarding the outer electrode 3 on the ridge portion between two surfaces adjacent to each other among the first surface A1, the second surface A2, the fifth surface B1, and the sixth surface B2 is defined as eR.

The thickness of the outer electrode 3 on the outer periphery of the multilayer body 2 is not constant. The thickness of the outer electrode 3 is smallest at the ridge portions R1 between two adjacent surfaces in the multilayer body 2. In the multilayer ceramic capacitor 1 of the example embodiment, eT1 and eT2 are about 5 μm or more and about 18 μm or less, and eW1 and eW2 are about 5 μm or more and about 18 μm or less, for example. In addition, eR is about 3 μm or more and about 16 μm or less, for example.

Measurement of the dimensions of g1, g2, e1, and e2 of the outer electrodes 3 is performed, for example, as follows. The multilayer ceramic capacitor 1 is placed on a glass table, and the dimensions of g1, g2, e1, and e2 of the outer electrodes 3 on the first surface A1, the second surface A2, the fifth surface B1, or the sixth surface B2 of the multilayer ceramic capacitor 1 are measured using a high-accuracy image dimension measurement system LM-1000 (manufactured by KEYENCE CORPORATION) in a high-accuracy measurement mode (catalog value ±0.7 μm).

However, the measurement method is not limited thereto, and it is also possible to perform measurement using an optical microscope capable of high-magnification imaging (such as VHX-8000 manufactured by KEYENCE CORPORATION). In the case of this method, in order to detect edges of the outer electrodes 3, scanning for positions at which focus is achieved is performed by manual operation. Then, end portions thereof are detected as edges and length measurement is performed.

Measurement of the dimensions of eT1, eT2, eW1, eW2, and eR of the outer electrode 3 is performed, for example, as follows. Polishing is performed to a position of ½ in the first direction L in the outer electrode 3 having the longest length in the first direction L among the outer electrodes 3 on the first surface A1, the second surface A2, the fifth surface B1, or the sixth surface B2, and a cross section extending in the lamination direction T and the second direction W is exposed. In the cross section, each dimension is measured at a magnification of 2500× or more using an optical microscope (such as VHX-8000 manufactured by KEYENCE CORPORATION).

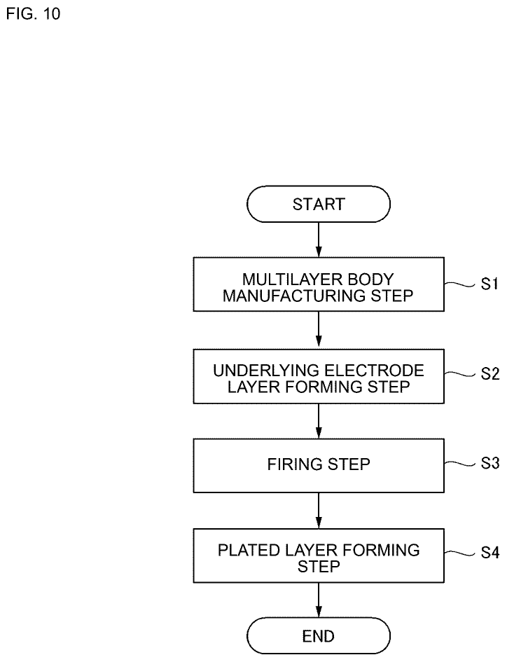

Next, a non-limiting example of a manufacturing method for the multilayer ceramic capacitor 1 according to the example embodiment is described. FIG. 10 is a flowchart depicting the manufacturing method for the multilayer ceramic capacitor 1 according to the present example embodiment.

First, material sheets are prepared in which patterns of the inner electrodes 5 are printed with a conductor paste on ceramic green sheets for lamination obtained by forming ceramic slurry in a sheet shape. Then, the material sheets are stacked such that, between adjacent material sheets, the patterns of the inner electrodes 5 are offset from each other in the length direction by a half pitch. Further, ceramic green sheets for the outer layer portion that each become an outer layer portion are stacked on both sides of the stacked material sheets, and thermocompression bonding of the sheets is performed to form a mother block member. Then, the mother block member is cut along cutting lines to manufacture the multilayer body 2. After the multilayer body 2 is manufactured, it is fired in a predetermined atmosphere at a predetermined temperature to manufacture a fired multilayer body.

Thereafter, by using a dipping method, a paste for the underlying electrode layers 30 that becomes the underlying electrode layers 30 is applied to the multilayer body 2 from the third surface C1 side and the fourth surface C2 side. At this time, the paste for the underlying electrode layers 30 is also applied on the first surface A1, the second surface A2, the fifth surface B1, and the sixth surface B2 of the multilayer body 2. At this time, a region in which the underlying electrode layer 30 is formed can be controlled by controlling the depth of dipping into the paste for the underlying electrodes layers during the dipping method, the amount, viscosity, and height of the paste for the underlying electrodes layers, and the number of fired multilayer bodies dipped at the same timing.

Thereafter, the multilayer body 2 on which the underlying electrode layers 30 are formed is fired in an oxidizing atmosphere in which nitrogen and water are continuously supplied. It is preferable that the firing temperature be about 600 °C or more and about 900 °C or less, for example.

Next, the inner plated layers 31a that are Ni plated layers are first formed on the outer periphery of the underlying electrode layers 30 so as to cover the underlying electrode layers 30. Next, the outer plated layers 31b that are Sn plated layers are formed on the outer periphery of the inner plated layers 31a so as to cover the inner plated layers 31a. Through the above steps, the multilayer ceramic capacitor 1 is manufactured. At this time, the total thickness and the like of the outer electrodes can also be controlled on the basis of a plating time and a current density for forming the plating.

Next, results of validation of effects of the multilayer ceramic capacitor 1 of the present example embodiment are described. In the following validation, 20 multilayer ceramic capacitors 1 (sample Nos. 1 to 20) were picked up from each of three lots (lot 1, lot 2, and lot 3) of the multilayer ceramic capacitor 1 according to the present example embodiment.

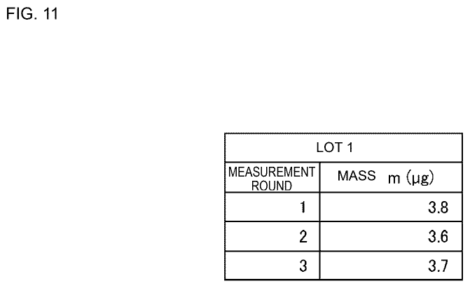

FIG. 11 is a table showing results that were obtained by measuring the weights of 100 ceramic capacitors 1 in lot 1 and calculating the weight per capacitor and were obtained by performing the measurement three times while selecting different 100 ceramic capacitors 1. As shown in the table, the mass of the ceramic capacitors 1 used in the validation was about 3.6 μg to about 3.8 μg, for example. e11 and e12 of the 20 ceramic capacitors 1 (sample Nos. 1 to 20) picked up in each of lot 1, lot 2, and lot 3 were measured to obtain e1 therefrom, and further g1 was measured to obtain g1/e1. Further, eT1, eT2, eW1, eW2, and eR were measured in each ceramic capacitor 1. Then, insulation resistance and presence or absence of occurrence of tombstoning regarding each ceramic capacitor 1 were measured.

As described above, each symbol indicates the following.
Dimension of the first outer electrode 3A in the first direction L: e11 (μm)
Dimension of the second outer electrode 3B in the first direction L: e12 (μm)
e1=(e11+e12)/2 (μm)
Minimum distance in the first direction L between the first outer electrode 3A and the second outer electrode 3B: g1 (μm)
Maximum thickness of the outer electrode 3 on the first surface A1 in the normal direction to the first surface A1: eT1 (μm)
Maximum thickness of the outer electrode 3 on the second surface A2 in the normal direction to the second surface A2: eT2 (μm)
Maximum thickness of the outer electrode 3 on the fifth surface B1 in the normal direction to the fifth surface B1: eW1 (μm)
Maximum thickness of the outer electrode 3 on the sixth surface B2 in the normal direction to the sixth surface B2: eW2 (μm)
Minimum thickness in the normal direction to the surface of the multilayer body 2 regarding the outer electrode 3 on the ridge portion between two surfaces adjacent to each other among the first surface A1, the second surface A2, the fifth surface B1, and the sixth surface B2: eR (μm)

The insulation resistance was measured using an insulation resistance meter (such as R8340A manufactured by ADVANTEST CORPORATION). Then, when the insulation resistance was 100 MΩ or more, it was evaluated as good (G).

The multilayer ceramic capacitor 1 was soldered to a glass epoxy substrate having a thickness of about 1.6 mm in a reflow furnace using a Sn—3.0Ag—0.5Cu solder paste, for example. A peak temperature in the reflow furnace was set to about 250 °C (about 240 °C or more: about 10 seconds, about 220 °C or more: about 60 seconds), and an air atmosphere was used in the furnace. After the soldering, an appearance of the multilayer ceramic capacitor 1 was checked. When at least one of the outer electrodes 3 was lifted and separated from the solder on a substrate electrode, the multilayer ceramic capacitor 1 was determined to involve a tombstoning defect (occurrence of tombstoning). When neither of the outer electrodes 3 was lifted and separated from the solder on the substrate electrode, the multilayer ceramic capacitor 1 was determined to be a non-defective product.

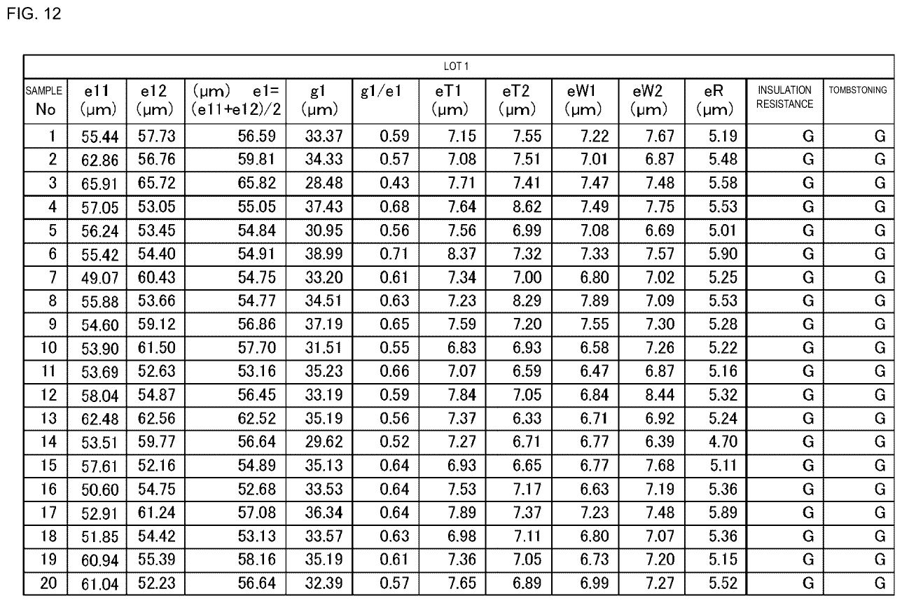

FIG. 12 is a table showing results of validation of the insulation resistance and presence or absence of occurrence of the tombstoning regarding the multilayer ceramic capacitors 1 of the example embodiment in lot 1. As shown in FIG. 12, in the multilayer ceramic capacitors 1 of lot 1, g1/e1 satisfied about 0.43≤g1/e1≤about 0.71, which is within a preferred range of about 0.31≤g1/e1≤about 1.00 in the present example embodiment. It was validated that, in this case, the insulation resistance was within a favorable range (G) and a favorable state (G) in which the tombstoning did not occur was achieved.

In the 20 ceramic capacitors 1 (sample Nos. 1 to 20) of lot 1, eT1 satisfied about 6.83 μm≤eT1≤about 8.37 μm, which is within a preferred range of about 5 μm≤eT1≤about 18 μm in the present example embodiment. eT2 satisfied about 6.33 μm≤eT2≤about 8.62 μm, which is within a preferred range of about 5 μm≤eT2≤about 18 μm in the present example embodiment. eW1 satisfied about 6.47 μm≤eW1≤about 7.89 μm, which is within a preferred range of about 5 μm≤eW1≤about 18 μm in the present example embodiment. eW2 satisfied about 6.39 μm≤eW2≤about 8.44 μm, which is within a preferred range of about 5 μm≤eW2≤about 18 μmin the present example embodiment. eR satisfied about 4.7 μm≤eR≤about 5.9 μm, which is within a preferred range of about 3 μm≤eR≤about 16 μm in the present example embodiment.

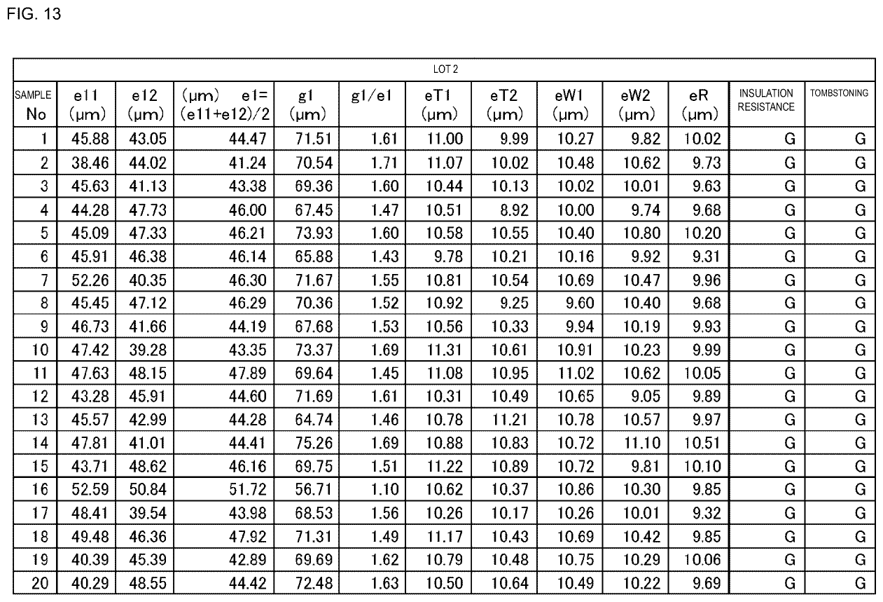

FIG. 13 is a table showing results of validation of the insulation resistance and presence or absence of occurrence of the tombstoning regarding the multilayer ceramic capacitors 1 of the example embodiments in lot 2. As shown in FIG. 13, in the multilayer ceramic capacitors 1 of lot 2, g1/e1 satisfied about 1.1≤g1/e1≤about 1.71, which is within a range of about 0.31≤g1/e1≤about 2.00 in the present example embodiment. It was validated that, in this case, the insulation resistance was within a favorable range (G) and a favorable state (G) in which the tombstoning did not occur was achieved.

In the 20 ceramic capacitors 1 (sample Nos. 1 to 20) of lot 2, eT1 satisfied about 9.78 μm≤eT1≤about 11.31 μm, which is within the preferred range of about 5 μm≤eT1≤about 18 μm in the present example embodiment. eT2 satisfied about 8.92 μm≤eT2≤about 11.21 μm, which is within the preferred range of about 5 μm≤eT2≤about 18 μm in the present example embodiment. eW1 satisfied about 9.60 μm≤eW1≤about 11.02 μm, which is within the preferred range of about 5 μm≤eW1≤about 18 μm in the present example embodiment. eW2 satisfied about 9.05 μm≤eW2≤about 11.10 μm, which is within the preferred range of about 5 μm≤eW2≤about 18 μm in the present example embodiment. eR satisfied about 9.31 μm≤eR≤about 10.51 μm, which is within the preferred range of about 3 μm≤eR≤about 16 μm in the present example embodiment.

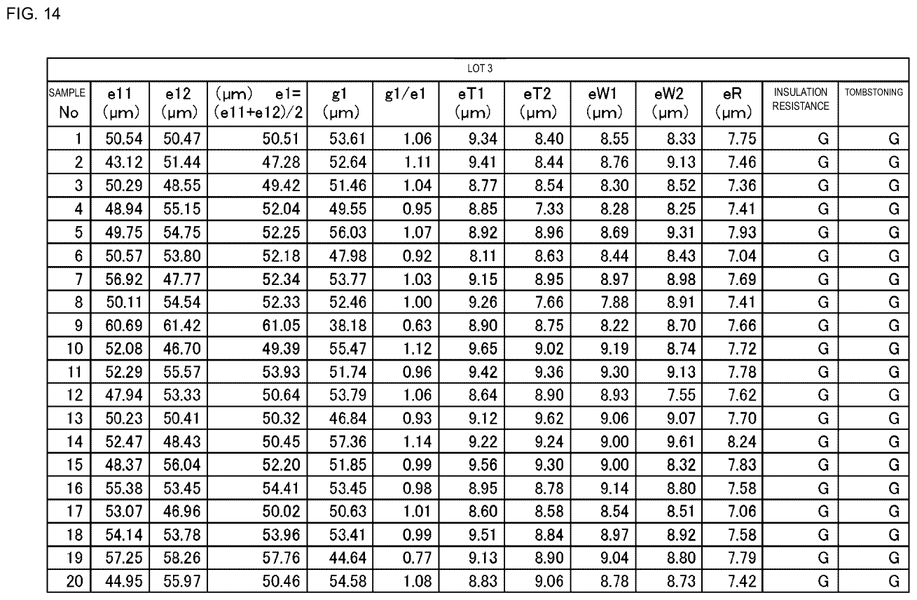

FIG. 14 is a table showing results of validation of the insulation resistance and presence or absence of occurrence of the tombstoning regarding the multilayer ceramic capacitors 1 of the example embodiment in lot 3. As shown in FIG. 14, in the multilayer ceramic capacitors 1 of lot 3, g1/e1 satisfied about 0.63≤g1/e1≤about 1.14, which is within the range of about 0.31≤g1/e1≤about 2.00 in the present example embodiment. Further, it was validated that, in this case, the insulation resistance was within a favorable range (G) and a favorable state (G) in which the tombstoning did not occur was achieved.

In the 20 ceramic capacitors 1 (sample Nos. 1 to 20) of lot 3, eT1 satisfied about 8.11 μm≤eT1≤about 9.65 μm, which is within the preferred range of about 5 μm≤eT1≤about 18 μm in the present example embodiment. eT2 satisfied about 7.33 μm≤eT2≤about 9.62 μm, which is within the preferred range of about 5 μm≤eT2≤about 18 μm in the present example embodiment. eW1 satisfied about 7.88 μm≤eW1≤about 9.30 μm, which is within the preferred range of about 5 μm≤eW1≤about 18 μm in the present example embodiment. eW2 satisfied about 7.55 μm≤eW2≤about 9.61 μm, which is within the preferred range of about 5 μm≤eW2≤about 18 μm in the present example embodiment. eR satisfied about 7.04 μm≤eR≤about 8.24 μm, which is within the preferred range of about 3 μm≤eR≤about 16 μm in the present example embodiment.

Although example embodiments of the present invention have been described above, the present invention is not limited thereto, and various modifications are possible as described in the modifications of the inner electrodes 5 and the modifications of the outer electrodes 3 described above.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer ceramic capacitor comprising:
a multilayer body including a first surface and a second surface facing each other in a lamination direction, a third surface and a fourth surface facing each other in a first direction intersecting the lamination direction, and a fifth surface and a sixth surface facing each other in a second direction intersecting the lamination direction and the first direction; and
outer electrodes including a first outer electrode on the third surface, the first surface, the second surface, the fifth surface, and the sixth surface, and a second outer electrode on the fourth surface, the first surface, the second surface, the fifth surface, and the sixth surface; wherein
a dimension in the first direction is about 0.150 mm or more and about 0.170 mm or less;
a dimension in the second direction is about 0.075 mm or more and about 0.085 mm or less;
a dimension in the lamination direction is about 0.050 mm or more and about 0.100 mm or less; and
as viewed from the first surface side, about 0.31≤g1/e1≤about 2.00 where e1 is defined as (e11+e12)/2 obtained by dividing, by 2, a sum of a dimension e11 of the first outer electrode in the first direction and a dimension e12 of the second outer electrode in the first direction at a position in the second direction on the first surface at which a distance in the first direction between the first outer electrode and the second outer electrode is a minimum distance g1.

2. The multilayer ceramic capacitor according to claim 1, wherein about 0.31≤g1/e1≤about 1.00.

3. The multilayer ceramic capacitor according to claim 1, wherein a mass m satisfies about 1 μg≤m≤about 10 μg.

4. The multilayer ceramic capacitor according to claim 1, wherein
in a case where, in a cross section that extends in the lamination direction and the second direction and passes through a center of the outer electrode in the first direction at positions at which a dimension of the outer electrode in the first direction is a maximum on the first surface, the second surface, the fifth surface, and the sixth surface;
a maximum thickness of the outer electrode on the first surface in a normal direction to the first surface is defined as eT1;
a maximum thickness of the outer electrode on the second surface in a normal direction to the second surface is defined as eT2;
a maximum thickness of the outer electrode on the fifth surface in a normal direction to the fifth surface is defined as eW1;
a maximum thickness of the outer electrode on the sixth surface in a normal direction to the sixth surface is defined as eW2; and
a minimum thickness in a normal direction to a surface of the multilayer body regarding the outer electrode on a ridge portion between two surfaces adjacent to each other among the first surface, the second surface, the fifth surface, and the sixth surface is defined as eR;
eT1 and eT2 are about 5 μm or more and about 18 μm or less;
eW1 and eW2 are about 5 μm or more and about 18 μm or less;
and eR is about 3 μm or more and about 16 μm or less.

5. The multilayer ceramic capacitor according to claim 1, wherein, as viewed from the fifth surface side, about 0.31≤g2/e2≤about 2.00 where e2 is defined as (e21+e22)/2 obtained by dividing, by 2, a sum of a dimension e21 of the first outer electrode in the first direction and a dimension e22 of the second outer electrode in the first direction at a position in the lamination direction on the fifth surface at which a distance in the first direction between the first outer electrode and the second outer electrode is a minimum distance g2.

6. The multilayer ceramic capacitor according to claim 1, wherein the multilayer body includes rounded ridge portions and rounded corner portions.

7. The multilayer ceramic capacitor according to claim 1, wherein the multilayer body includes dielectric layers and inner electrodes.

8. The multilayer ceramic capacitor according to claim 7, wherein the multilayer body includes Sn layers at interfaces between the dielectric layers and the inner electrodes.

9. The multilayer ceramic capacitor according to claim 7, wherein a thickness of each of the dielectric layers is about 0.40 μm or more and about 3.00 μm or less and a thickness of each of the inner electrodes is about 0.20 μm or more and about 1.50 μm or less.

10. The multilayer ceramic capacitor according to claim 7, wherein each of the dielectric layers includes BaTiO₃.

11. The multilayer ceramic capacitor according to claim 7, wherein each of the inner electrodes includes Ni.

12. The multilayer ceramic capacitor according to claim 1, wherein the multilayer body includes side gap portions.

13. The multilayer ceramic capacitor according to claim 1, wherein each of the outer electrodes includes an underlying electrode layer and a plated layer.

14. The multilayer ceramic capacitor according to claim 13, wherein the plated layer includes a Ni layer and a Sn layer.

15. The multilayer ceramic capacitor according to claim 13, wherein each of the underlying electrode layers includes metal and glass.

16. The multilayer ceramic capacitor according to claim 13, wherein each of the underlying electrode layers includes Ni.

17. The multilayer ceramic capacitor according to claim 13, wherein the multilayer body includes inner electrodes, each of the underlying electrode layers includes Cu and each of the inner electrodes is Ni.
